(19) United States
(12) Patent Application Publication
(10) Pub. No.: US 2013/0064598 A1
(43) Pub. Date: Mar. 14, 2013

(54) TOOL FOR SMOOTHING ELASTIC SEALANT JOINTS

(71) Applicant: Ben Williamson, Stockport (GB)

(72) Inventor: Ben Williamson, Stockport (GB)

(21) Appl. No.: 13/634,733

(22) PCT Filed: Feb. 18, 2011
(86) PCT No.: PCT/GB11/00229

§ 371 Date: Nov. 27, 2012

(30) Foreign Application Priority Data
Mar. 16, 2010 (GB) 1004314.9

(51) Int. Cl. B05C 21/00

(52) U.S. Cl. CPC B05C 21/00
USPC 401/267

(57) ABSTRACT

A sealant contour forming tool comprises an elongate substantially cylindrical body having an open front end and an open rear end. The front end has an edge lying on a plane which extends obliquely to a central axis of the body. The body is formed from a resilient material and further comprises a longitudinal opening extending longitudinally between the front open end and the rear open end. The longitudinal opening being operable to resiliently widen and narrow in response to an appropriate force applied to the body adjacent the elongate opening.

The present invention relates to a tool operable to form a contour on an applied bead of sealant material.

The term “sealant material” as used herein means the same as “caulking material” and refers to any flowable, settable or non-settable material, such as mastic, silicone or similar, which is used to provide a seal, particularly in a narrow opening or groove between adjacent substrate materials.

Such sealant materials are conveniently provided in cylindrical containers having a nozzle at one end and are applied, as a bead, to joints between substrate materials using a caulking gun. In use, the sealant material is typically applied and pressed into the joint, any excess sealant material is removed and the surface thereof is preferably smoothed. This may be done using a finger or by using a smoothing/contouring tool.

U.S. Pat. No. 7,127,789 discloses a tool in the form of an elongated square tubular member having an open front end which tapers rearwardly across one corner to an apex to provide a scoop for removal and shaping of the sealant material. However, this tool is disadvantaged in that, in use, the scoop tends to remove excessive material and leaves an undesirable surface contour. Furthermore, versions of this tool have at their rear end either a flap closure or an end wall provided with an opening. This results in removed quantities of sealant material tending to pass through the tool and out of its rear end, which can tend to make continued use of the tool more difficult.

Patent document WO2008/107653 discloses a tool in the form of a shallow cylindrical ring made of plastics material and detached from an end of a conventional container of sealant material, which can be pressed and thereby deformed to an ovoid shape and then pulled across a freshly applied bead of sealant material in order to contour its surface. Again, this tool is disadvantaged as it does not provide for collection of excess removed sealant material. Furthermore, this relatively simple cylindrical ring does not provide for a sufficiently effective cutting edge which is required to cut through a bead of sealant material and leave the desired clean contoured surface thereon. This tool is further disadvantaged in that requires adaptation of the sealant container.

It is an object of the present invention to overcome the disadvantages of the above-mentioned known tools and provide an improved sealant contour forming tool.

According to the present invention there is provided a sealant contour forming tool comprising an elongate substantially cylindrical body having an open front end and an open rear end, the front end comprising an edge lying on a plane which extends obliquely to a central axis of the body, wherein the body is formed from a resilient material and further comprises an elongate opening extending longitudinally between the front open end and the rear open end, the elongate opening being operable to resiliently widen and narrow in response to an appropriate force applied to the body adjacent the elongate opening.

The sealant contour forming tool may further comprise a rear closure. The rear closure is advantageously integrally formed with the body and more advantageously hingedly attached to the body.

The rear closure is advantageously hingedly attached to the body by means of a weakened region of material between the rear closing portion and the body.

The edge at the open front end may be configured to include a notch at a location remote from its most forward region, the notch being of a curving shape and sized for scraping a finger of a user.

The body may be of a length which is at least as great as its diameter. Alternatively, the body may be of a length which is at least one and a half times the size of its diameter.

Also according to the present invention there is provided a combination of a container containing sealant and a sealant contour forming tool as claimed in any of the preceding claims. The sealant contour forming tool is advantageously disposed around the peripheral wall of the container and is removable therefrom.

The invention will be described further, by way of example, by reference to the accompanying drawings, in which:

FIG. 1 is a perspective view of a practical embodiment of a sealant contour forming tool in accordance with the present invention;

FIG. 2 is an alternative perspective view of the sealant contour forming tool of FIG. 1, showing a hinged rear closure;

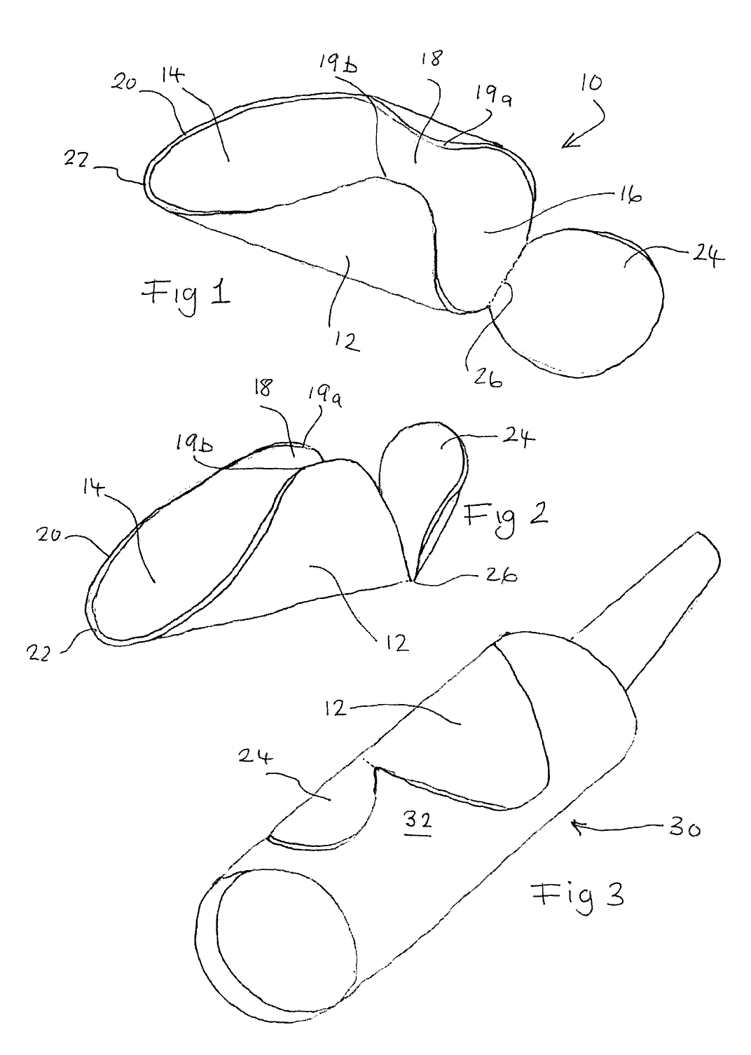

FIG. 3 is a perspective view of a combination of a container and the sealant contour forming tool of FIG. 1 disposed thereon;

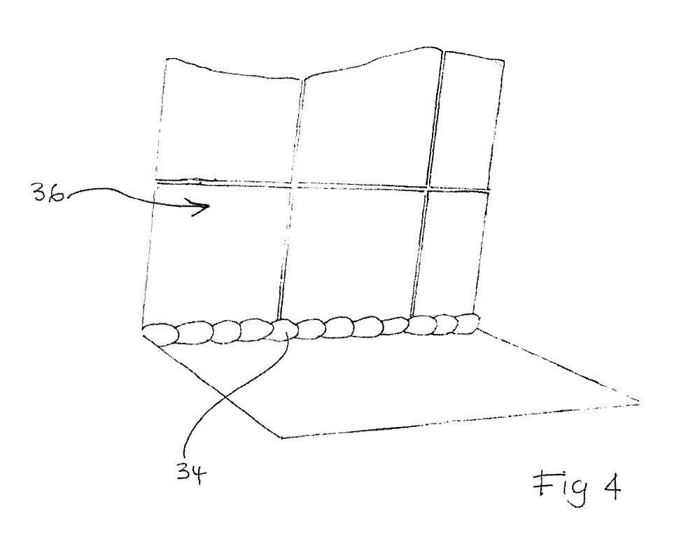

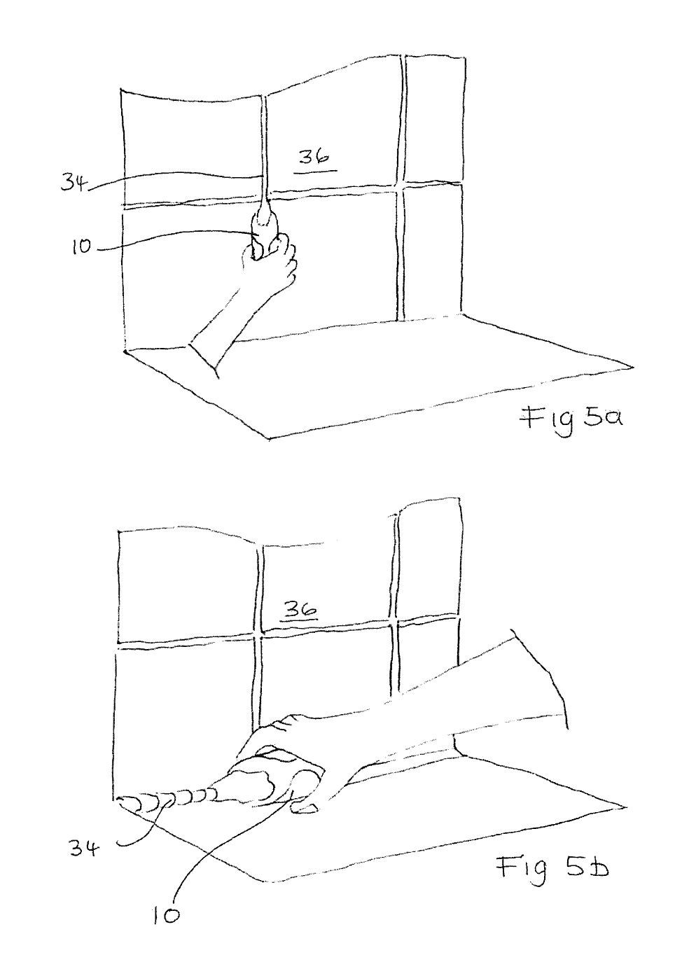

FIG. 4 is a perspective view showing a bead of sealant as applied from a conventional container nozzle;

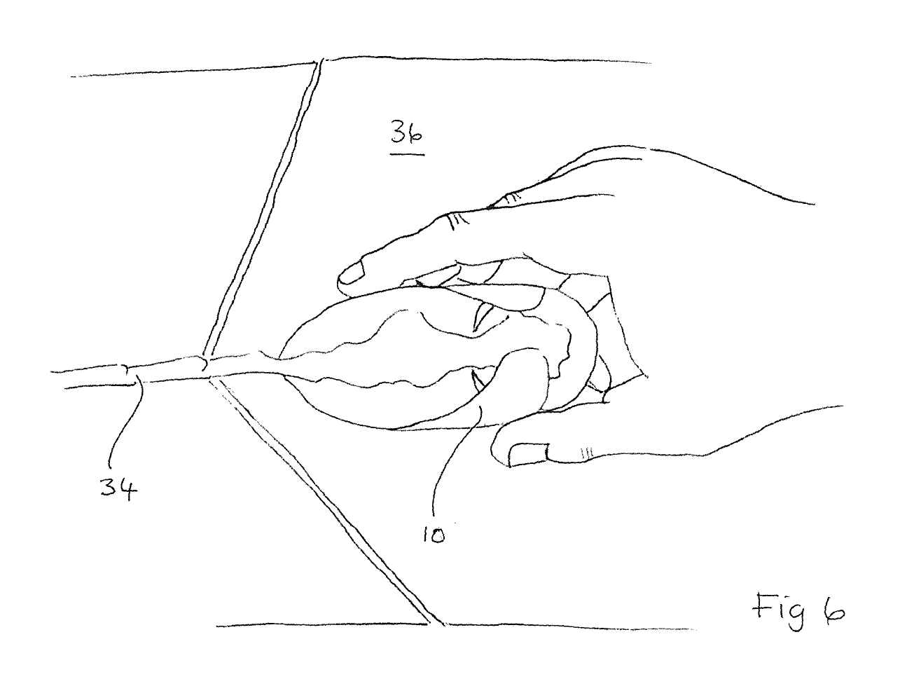

FIGS. 5a and 5b are perspective views showing how the tool of FIGS. 1 and 2 is used to form a surface contour to the bead of sealant material; and

FIG. 6 is a similar perspective view to FIGS. 5a and 5b, except it is enlarged, and shows how the tool of FIGS. 1 and 2 is used to form a surface contour to the bead of sealant material.

Referring to FIGS. 1 and 2 a sealant forming contour tool 10, according to the present invention, comprises an elongate substantially cylindrical body 12. The body 12 is approximately 10 cm long at its longest extent and has an outer diameter of approximately 5 cm. It is made of a plastics material, such as, for example, PVC or polyurethane or nylon and has a thickness of approximately between 1 mm and 1.5 mm. The body is resiliently flexible and deformable in response to an appropriate force applied to it and reforms into its original shape upon removal of the applied force.

The body has a front opening 14, a rear opening 16 and an elongate opening 18. The elongate opening 18 has edges 19a and 19b and extends between the front opening 14 and the rear opening 16 and joins the front and rear openings together.

The front opening 14 has an oblique forward edge 20 extending at an angle of approximately 45° relative to the a central axis of the body 12. At its most forward region 22, the edge 20 is substantially straight (non-curving) for a distance of approximately 20 mm.

The tool 10 further comprises a rear closure 24 which is integrally formed with the body 12. The rear closure 24 is hingedly connected to the body 12 by means of a weakened region 26, of the material from which the body and closure is made, extending laterally across between the body and the rear closure. FIG. 1 shows the rear closure 24 in an open and flat position, whilst FIG. 2 shows the rear closure 24 in a closed position.

Referring to FIG. 3, a combination 28, according to the present invention, comprises a sealant container 30 and a tool 10, as described above. As shown in FIG. 3, the tool 10, having the rear closure 24 open, as shown in FIG. 1, is specifically dimensioned such that it can be stored around the peripheral wall of the container 30 and is detachably attached to the container by means of the resilient nature of its body 12. The tool 10 is attached around the cylindrical wall 32, of the container 30, by simply pushing the longitudinal opening 18, of the body 12, against the container wall 32. With the application of an appropriate force, the longitudinal opening 18 widens such that the edges 19a and 19b separate and ride over the cylindrical wall 32 (of the container 30) until they pass the widest part of the container (i.e. the outer diameter) on opposite sides thereof. After the edges 19a and 19b pass the widest part of the container 30, they move closer towards each other and the longitudinal opening 18 narrows to its original width and the body 12 regains its original shape and thereby the tool 10 is attached to the container 30, around the container wall. It is not necessary to have a frictional fit between the tool 12 and the container 30 as raised portions integrally formed on the container or bands disposed around the circumference of the container wall 32 can prevent the tool 10 from sliding along the container 30 or off the ends of the container 30. To detach the tool 10 from the container 30, the tool 10 is simply pulled away from the wall 32 such that the longitudinal opening 18 is widened as the edges 19a and 19b ride over the cylindrical wall 32 until the tool 10 is completely detached from the container 30 at which time the body 12 reverts to its original shape due to the resilient nature of the material from which it is formed.

In use, if the tool 10 is attached to a container 30, the tool is first detached as described above and the rear closure 24 is closed such as to close the rear opening 16 and provide a closed rear end, as shown in FIG. 2. The container 30 is then used to apply a sealant, such as silicone, liberally as a bead 34 to a joint, such as a substantially right angled corner in a bathroom or kitchen at the base of a tiled wall surface 36, as shown in FIG. 4. Then, referring also to FIGS. 5a, 5b and 6, the tool 10 is grasped by a user who applies slight manual pressure to the body 12 around the region of the front opening 14 such the front opening 14 is deformed so that the edge 20, which provides a cutting edge for the sealant, is formed into a desirable curving shape. The tool 10 is then pushed with the edge 20 leading through the bead 34, as shown in FIGS. 5a, 5b and 6, in order to cut through and scoop away excess sealant material and create a smooth curving surface at the joint. Such a curving surface is known to provide the most reliable and durable seal at this location. At the same time, the removed, excess sealing material is gathered into and accumulates inside the body 12 wherein the rear closure 24 positioned to provide a closed rear end allows the tool 10 to be used as a receptacle to collect the removed excess sealant therein. The body 10 is of such a size that the blading off operation, as just described, can be carried out for a reasonable length of sealant bead before the receptacle, which is the body 12, has to be emptied out. This makes for efficient working. Emptying out can be accomplished just by tipping out from the front opening 14 or the rear opening 16, when the closure 24 is opened.

The tool 10 is chosen to be of a size and material thickness which provides the most suitable resilience to enable the body 12 to deform both around the region of the longitudinal opening 18, to facilitate attachment of the tool to a container, and around the front opening 14 to form a desired shape of edge 20. The thickness of the material must also be chosen to provide an efficient cutting edge 20, for sealant contouring, particularly of silicone sealing material used in internal locations. The inner diameter of the body 12 is selected such the body can fit around at least a substantial part of the outer circumference of the wall 32, of container 30.

The foregoing is illustrative and not limitative of the scope of the invention and modifications in detail are possible in other versions compared to the illustrated embodiments herein.

1. A sealant contour forming tool comprising an elongate substantially cylindrical body having an open front end and an open rear end, the front end comprising an edge lying on a plane which extends obliquely to a central axis of the body, wherein the body is formed from a resilient material and further comprises a longitudinal opening extending longitudinally between the front open end and the rear open end, the longitudinal opening being operable to resiliently widen and narrow in response to an appropriate force applied to the body adjacent the elongate opening.

2. A sealant contour forming tool as claimed in claim 1, further comprising a rear closure.

3. A sealant contour forming tool as claimed in claim 2 wherein the rear closure is integrally formed with the body.

4. A sealant contour forming tool as claimed in claim 2, wherein the rear closure is hingedly attached to the body.

5. A sealant contour forming tool as claimed in claim 2, wherein the rear closure is hingedly attached to the body by means of a weakened region of material between the rear closure and the body.

6. A sealant contour forming tool as claimed in claim 1 wherein the body is of a length which is at least as great as its diameter.

7. A sealant contour forming tool as claimed in claim 1 wherein the body is of a length which is at least one and a half times the size of its diameter.

8. A combination of a container containing sealant and a sealant contour forming tool, the sealant contour forming tool comprising an elongate substantially cylindrical body having an open front end and an open rear end, the front end comprising an edge lying on a plane which extends obliquely to a central axis of the body, wherein the body is formed from a resilient material and further comprises a longitudinal opening extending longitudinally between the front open end and the rear open end, the longitudinal opening being operable to resiliently widen and narrow in response to an appropriate force applied to the body adjacent the elongate opening.

9. A combination as claimed in claim 8, wherein the sealant contour forming tool is disposed around the peripheral wall of the container and is removable therefrom.

10. (canceled)

11. A combination as claimed in claim 9, wherein the sealant contour forming tool further comprises a rear closure.

12. A combination as claimed in claim 9, wherein the rear closure is integrally formed with the body.

13. A combination as claimed in claim 9, wherein the rear closure is hingedly attached to the body.

14. A combination as claimed in claim 9, wherein the rear closure is hingedly attached to the body by means of a weakened region of material between the rear closure and the body.

15. A combination as claimed in claim 9, wherein the body is of a length which is at least as great as its diameter.

16. A combination as claimed in claim 9, wherein the body is of a length which is at least one and a half times the size of its diameter.
